(19) United States
(12) Patent Application Publication
(10) Pub. No.: US 2006/0072892 A1
(43) Pub. Date: Apr. 6, 2006

(54) Flexible optical cabling

(76) Inventors: Roland Hans Serrander, Stockholm (SE); Peter LoCurzio, Hudiksvall (SE)

Correspondence Address: ERICSSON INC., 6300 LEGACY DRIVE, M/S EVR C11, PLANO, TX, 75024, US

(21) Appl. No.: 10/538,975

(22) PCT Filed: Dec. 19, 2002
(86) PCT No.: PCT/SE02/02427

§ 371 Date: Jun. 14, 2005

(51) Int. Cl. G02B 6/00

(52) U.S. Cl. 385/135; 385/100

(57) ABSTRACT

The present invention relates to an arrangement and a method for flexible installation of an optical patch cable PC1 in a telecommunication station TS between equipment AE4, AE7 in the station. The arrangement comprises a micro duct 1 for guidance of the patch cable. The duct have duct end openings E4, E7 related to the equipment.

### TECHNICAL FIELD OF THE INVENTION

The present invention relates to methods and arrangements for flexible installation of optical patch cables in a telecommunication cabinet.

### DESCRIPTION OF RELATED ART

Traditionally, cross connectors have been used in telecommunication systems to enhance flexibility. By using cross connecting patch cables in a telecommunication station it is possible to prepare for a variable number of subscribers using the station. Cross connecting patch cables makes it possible to easy re-configure the station when for example subscribers are to be added, taken away or moved between different areas that are handled by the station.

Due to extension of subscribers and computer nets, additional patch cables have been introduced in telecommunication cabinets. The reason is the further need for flexibility, backward compatibility and redundancy. By large concentration of subscribers, optical patch cables have turned out to be advantageous and profitable. The organization of equipment in a station becomes more important by large concentration of patch cables in the station. Optical patch cables are normally terminated in so-called optical termination frames. The optical termination frame makes easy upgrading and downgrading possible.

The management of cables in general is a well-known problem. Loose cables can for example become entangled in each other or in pieces of equipment. In the international patent application WO 98/33252 is disclosed a method for installing optical patch cables in duct systems or like tubular runways arranged in dwelling rooms in apartment blocks. In telecommunication cabinets where several hundred or more cables are used, the problem is particularly acute. A different type of problem arises in telecommunication cabinets compared to apartment blocks due to less space and increased need of flexibility. One solution is to secrete the cables away beneath covers or enclosures. These covers or enclosures can be made detachable to provide access to the cables. Nevertheless, there is still a problem when a user gains access to, say, the rear of an equipment rack, the cables are randomly and loosely arranged. Indeed, it is difficult to trace and, where necessary, replace, cables since the route each cable follows is not immediately apparently or readily accessible. Furthermore a cable strain due to bending torque's acting on cables in the system may cause problems. In particular fiber optic cables can develop faults, or even may break in similar circumstances. In the international patent application WO 98/33252 is disclosed a cabinet which has a recess for equipment and comprises a retractable frame which forms a cable duct for cables to and from the rack interior, the frame being positioned at the side of the recess. However, flexibility problems still remain using the solution in the international application when optical patch cables are to be added, taken away or moved within the cabinet. Another problem is that patch cable connectors often are assembled to a patch cable in a factory before installation. Patch cables are therefore only available in certain lengths. This may cause surplus of the patch cable length when mounted in the cabinet. This excess length takes up a great deal of space in the cabinet.

### SUMMARY OF THE INVENTION

The present invention relates to a problem how to enhance flexibility in a telecommunication station regarding adding, taking away and moving optical patch cables in the station when subscriber penetration conditions change.

Another problem is the excess length of optical patch cables when connectors are assembled to both patch cable ends before the patch cable is installed in the cabinet.

A purpose with the invention is to facilitate re-configuration of the patch cables in dependence of subscriber penetration change. Another purpose is to connect equipment in a telecommunication station via optical patch cables with optimal length.

The problems are solved by the invention by a micro duct installed within the cabinet with duct end openings related to equipment in the cabinet. The micro duct is intended for guidance of an optical patch cable, which is to be installed between the equipment.

More in detail, the problems are solved by an arrangement comprising the micro duct installed within the station with duct end openings related to the equipment in the station. The arrangement further comprises means for feeding a patch cable through the duct and means for adjusting the patch cable length between equipment, and means for assembling a connector to at least one end of the patch cable.

The problems are solved by a method comprising the following step:
A micro duct is installed in the telecommunication station. The duct is installed with duct end openings related to the equipment in the station.
A patch cable is guided through the duct.
The patch cable length is adjusted between the equipment.
The connector is assembled to at least one end of the patch cable.

An advantage with the invention is flexible re-configuration of patch cables within the cabinet.

Another advantage is the optimal consumption of only necessary patch cable length.

Yet another advantage is that no complex system is necessary to take care of excess patch cable length.

Yet another advantage is the easy and safe installation of patch cables in the cabinet without draw and/or bend stresses.

Still another advantage is the possible pre-installation already in factories of the micro duct system in the cabinet.

Still yet another advantage is the possibility to use hybrid contacting i.e. type of contacting of the patch cable may be decided during installation of the patch cable in the cabinet and not in the factory.

The invention will now be described more in detail with the aid of preferred embodiments in connection with the enclosed drawings.

### BRIEF DESCRIPTION OF THE DRAWINGS

FIG. 1 shows a block schematic illustration of a telecommunication station comprising a cabinet in which an optical distribution frame is used as interface between an external cable system and equipment in the cabinet. The optical distribution frame is connected to the equipment via patch cables in micro ducts.

FIG. 2 shows a block schematic illustration of the telecommunication station comprising two cabinets with equipment connected to each other via a patch cable in a micro duct.

FIG. 3 shows examples of micro duct applications in the telecommunication station.

FIG. 4 shows a block schematic illustration of the telecommunication station comprising micro ducts in which more than one optical fiber is situated.

FIG. 5 shows a flowchart illustrating a method for installation of a patch cable.

### DETAILED DESCRIPTION OF EMBODIMENTS

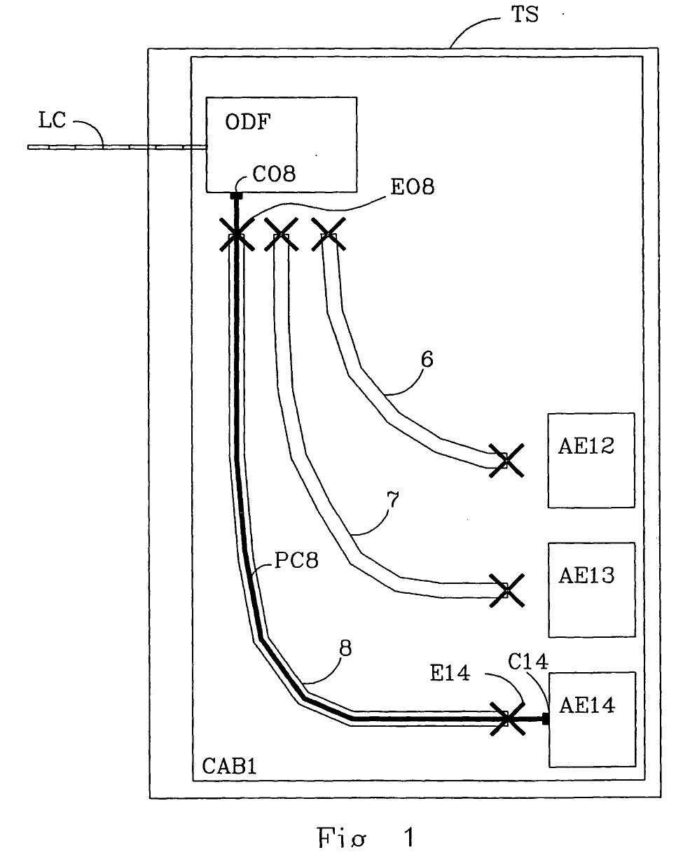

FIG. 1 discloses in a first embodiment a telecommunication station TS comprising a cabinet CAB1. The cabinet comprises equipment such as an optical distribution frame ODF. The optical distribution frame is the main distribution frame for a fiber optic system. It is where the line technology and the fiber optic transmission technology meet. The ODF is used as the interface between the optical fiber cable system represented by a line cable LC in FIG. 1, and equipment AE12-AE14 in the cabinet. The equipment AE12-AE14 can for example be transmission or switching equipment. An ODF may have a number of distributors with optical fiber connectors. All exchange lines can be terminated on one distributor with connectors from where it is jumpered via patch cords to the user side which is connected to other distributors. The ODF is a convenient place to put devices like optical splitters, optical combiners and equipment for conversion to electrical signals. According to the invention, micro ducts 6, 7 and 8 are installed in the cabinet between the distribution frame ODF and the equipment AE12-AE14. This installation is preferably done when the cabinet is equipped in the factory. The end openings EO8 and E14 of the micro duct 8 are hereby placed adjacent the optical distribution frame ODF and the equipment AE14. While the micro duct is installed in the factory the optical fiber connection between the equipment AE14 and the optical distribution frame ODF takes place “in field”. An optical patch cable is a short (less than twenty meters) flexible connectorized fiber element having one or a number of optical fibers in order to connect different network elements, i.e. equipment, in a flexible way. An optical patch cable without end connectors CO8, C14, or with only one end connector C14, is hereby preferably used. By using a patch cable not having end connectors in both ends, the patch cable might be adjusted in field to have the optimal length. Surplus cable length is hereby avoided. In this example a patch cable PC8 has the end connector C14 attached while the other end is free. The free patch cable end is inserted into the micro duct end opening E14 and the cable is for example blown through the duct by the aid of pressurised air. The cable length is thereafter adjusted to fit between the equipment AE14 and the optical distribution frame ODF. The connector CO8 is then assembled to the free end of the cable whereby the connectors are connected to the equipment ODF and AE14. CO8 is connected to the ODF and C14 is connected to the AE14. Depending on the need, for example due to subscriber penetration, one or several patch cables may be inserted in each micro duct 6, 7 and 8.

The arrangement used in the invention comprises means for feeding. The means is for example a mechanical device (carterpillar) or air (fiber blowing gun). As means for adjusting the patch cable, a fiber and cable cutter might be used. As means for assembling a connector, a fiber cleaving tool, fiber polisher, assembly tool for connectors or fusion splicing of a short connectorized fiber-element like pigtail or fan-out might be used.

A duct end opening can be related either directly or in-directly to equipment in the station. A duct can go either directly from equipment in the station to another equipment in the station, or via a wall entrance through-connection from equipment in one cabinet to equipment in another cabinet or location in the station.

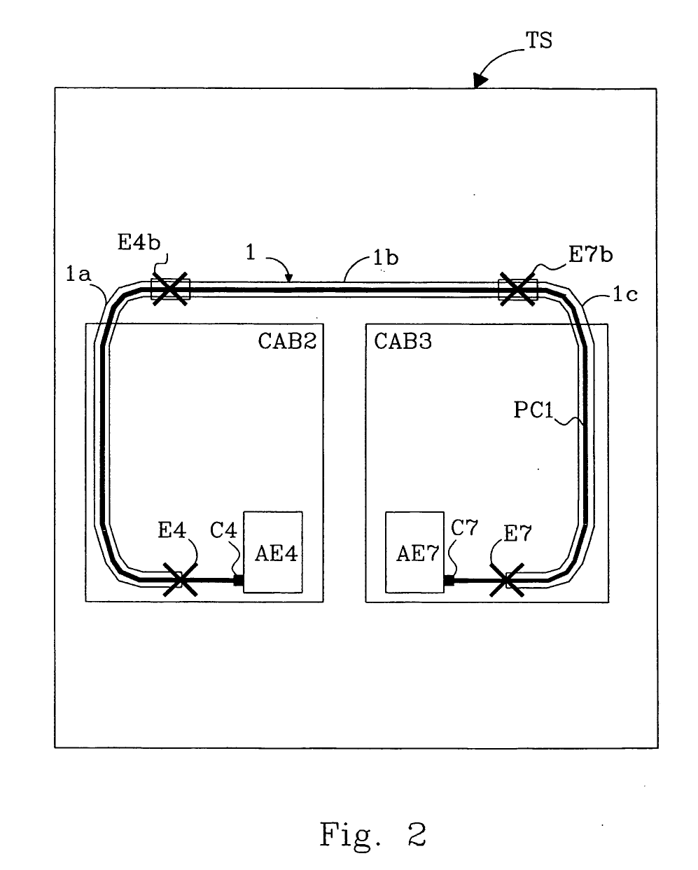

FIG. 2 discloses the telecommunication station TS which in this example comprises two cabinets CAB2 and CAB3. The cabinet CAB2 is equipped with equipment AE4 and a micro duct part 1a. The micro duct have one duct end opening E4 adjacent the equipment AE4 and the other end opening E4b located outside a wall entrance of the cabinet CAB2. The cabinet CAB3 is equipped with equipment AE7 and a micro duct part 1c. The micro duct have one duct end opening E7 adjacent the equipment AE7 and the other end opening E7b located outside the wall of the cabinet CAB3. In this embodiment the equipment AE4, AE7 in the two cabinets are to be connected to each other. The connection takes place “in field” by splicing the two ducts part 1a and 1c together via a micro duct part 1b. The spliced micro duct parts 1a, 1b and 1c together form a micro duct 1. A patch cable PC1 is inserted into the opening E4 of the micro duct 1 and blown through the duct. Connectors C4 and C7 are assembled to the cable ends when the cable length has been adjusted between the equipment. The connectors are then connected to the equipment AE4 and AE7.

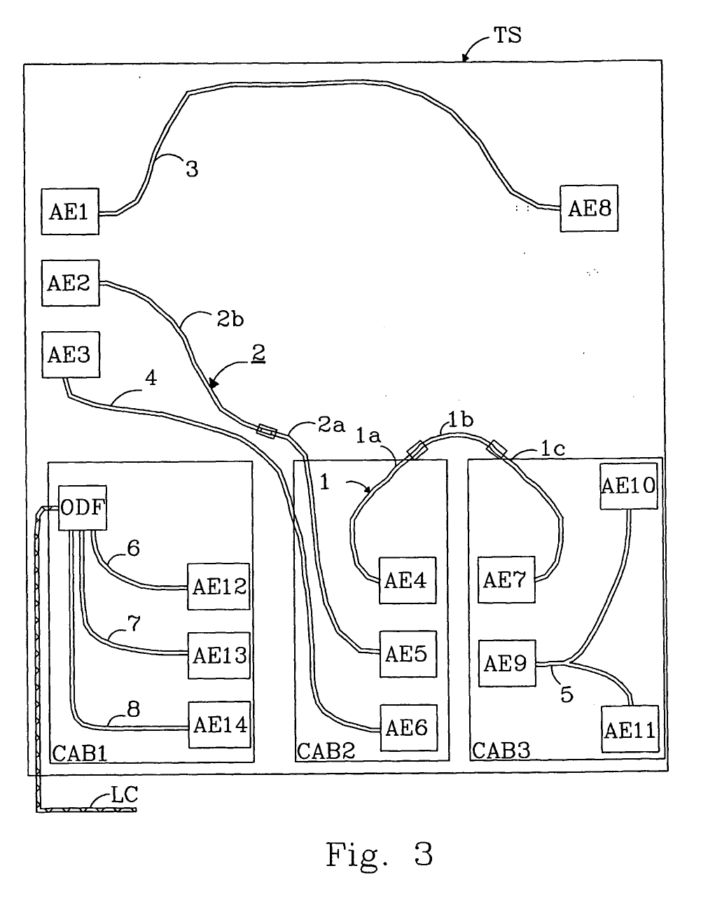

FIG. 3 discloses some examples of possible micro duct implementations. The examples shown in the two embodiments before can be seen also in the telecommunication station TS in FIG. 3. Beyond the examples before can be seen in FIG. 3 how a micro duct 3 is located with end openings adjacent equipment AE1 and AE8 in the station TS. A micro duct 2 comprises micro duct parts 2a and 2b. One end opening of part 2a is adjacent to equipment AE5 and the other end opening is related but not adjacent to equipment AE2. The part 2b has one end opening adjacent to AE2 and the other opening related but not adjacent to AE5. The two micro duct parts 2a and 2b are spliced together in field and form the micro duct 2. Another example shows a micro duct 4 guided through a cabinet wall entrance. The duct 4 has one opening adjacent equipment AE6 within the cabinet CAB2, and one opening adjacent equipment AE3 within the station TS but outside the cabinet CAB2. Yet another example discloses a micro duct 5 having three end openings, each opening adjacent to equipment AE9, AE10 or AE11.

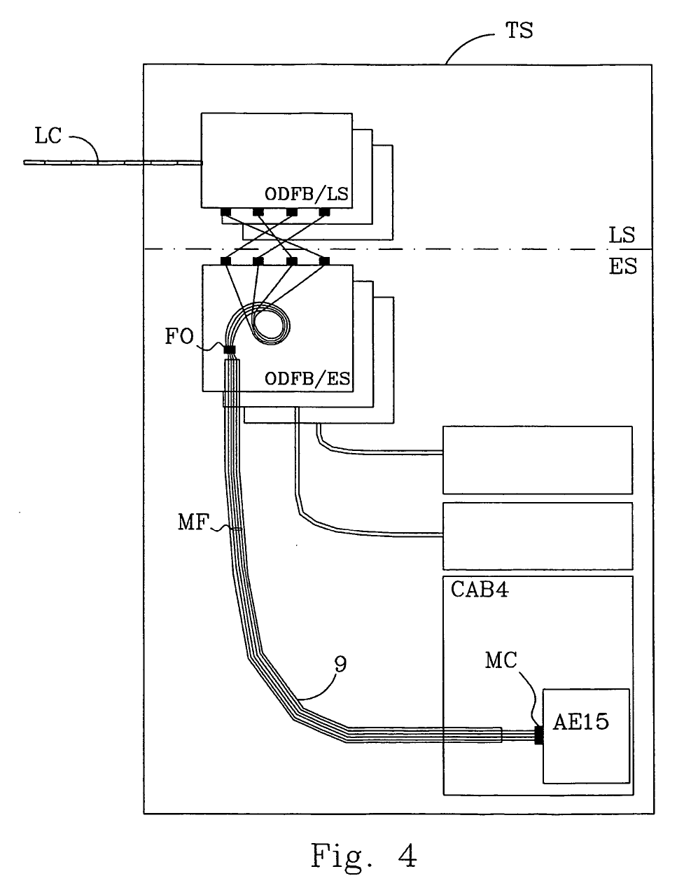

FIG. 4 discloses the telecommunication station TS which in this example comprises equipment AE15 connected to an ODF-box via an optical patch cable which is a multifiber MF situated in a micro duct 9. The multifiber in the example comprises four optical fibers. The telecommunication station TS has a line side LS and an exchange side ES. The equipment AE15 is located in a cabinet CAB4 on the exchange side ES. The ODF-box comprises two parts, one part ODFB/LS on the line side LS and one part ODFB/ES on the exchange side ES. The micro duct 9 is installed between the box ODFB/ES and the equipment AE15. The multifiber MF is fed through the duct and connected to the equipment AE15 via a multifiber connector MC in the cabinet CAB4. The multifiber is on the other end connected to the ODF-box ODFB/ES on the exchange side via a fan-out FO. The multifiber is distributed in the fan-out to four single circuit connectors in the ODF/ES. The single circuit connectors in the ODFB/ES on the exchange side are cross connected to single circuit connectors on ODFB/LS on the line side at which distribution takes place to the line cable LC.

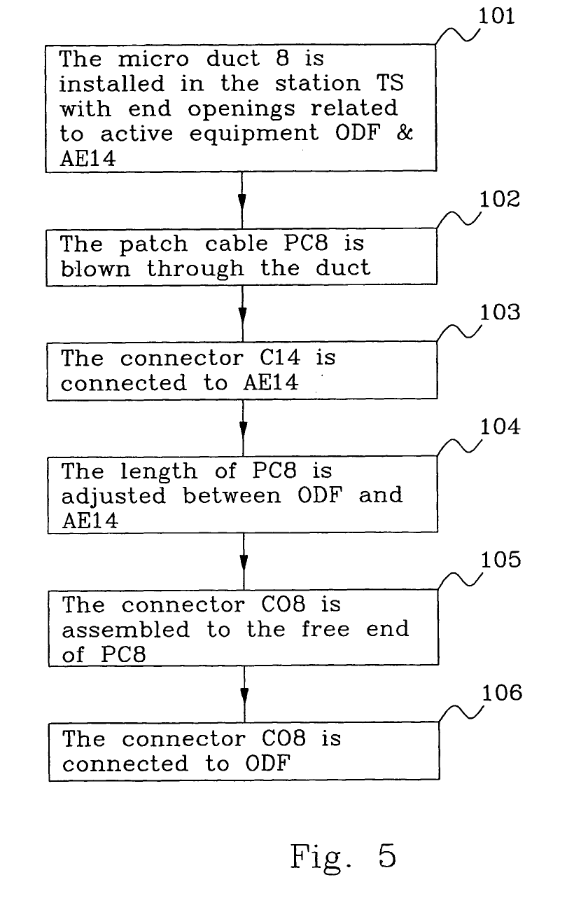

FIG. 5 discloses in a flowchart some of the steps of a method according to the invention. The flowchart is to be read together with the earlier shown FIG. 1. The method comprises the following steps:
The micro duct 8 is installed in the telecommunication station TS. The micro duct has the end opening E14 located adjacent the equipment AE14 and the end opening EO8 adjacent the optical distribution frame ODF. This step is shown in FIG. 4 by a block 101.
The patch cable PC8 with the end connector C14 assembled to one end is inserted with its free end into the opening E14 of the micro duct. The cable is blown through the duct by the aid of pressurised air. This step is shown in FIG. 4 by a block 102.
The connector C14 is connected to the equipment AE14. This step is shown in FIG. 4 by a block 103.
The length of the patch cable PC8 is adjusted between the optical distribution frame ODF and the equipment AE14. This step is shown in FIG. 4 by a block 104.
The connector CO8 is assembled to the free end of the patch cable. This step is shown in FIG. 4 by a block 105.
The connector CO8 is connected to the optical distribution frame ODF. This step is shown in FIG. 4 by a block 106.

The invention is of course not limited to the above described and in the drawings shown embodiments but can be modified within the scope of the enclosed claims.

1-6. (canceled)

7. An apparatus for flexible installation of an optical patch cable in a telecommunication station between equipment in the station, said apparatus comprising: a micro duct for guidance of the patch cable, the duct having duct end openings related to the equipment, the end openings being adapted to receive the patch cable for insertion into the micro duct.

8. The apparatus recited in claim 7, further comprising:
means for feeding the patch cable through the duct;
means for adjusting the patch cable length between the equipment; and,
means for assembling a connector to at least one end of the patch cable.

9. The apparatus recited in claim 7, wherein the duct comprises spliced duct parts.

10. The apparatus recited in claim 7, wherein the duct comprises more than two end openings.

11. A method for flexible installation of an optical patch cable in a telecommunication station between equipment in the station, said method comprising the steps of:
installing a micro duct in the telecommunication station, the duct being installed with duct end openings related to the equipment;
inserting a patch cable into the micro duct through one of the end openings;
feeding the patch cable through the duct and through another one of the end openings;
adjusting the patch cable length between the equipment; and,
assembling a connector to at least one end of the patch cable.

12. The method recited in claim 11, wherein the duct is guided through a cabinet wall entrance in the telecommunication station.
